(19) United States
(12) Patent Application Publication
(10) Pub. No.: US 2023/0250888 A1
(43) Pub. Date: Aug. 10, 2023

(54) BATTERY-POWERED METER COUPLING VALVE

(71) Applicant: Meter Technology Werks, LLC, Tampa, FL (US)

(72) Inventors: Matthew White, Tampa, FL (US); Eric Allard, Plant City, FL (US); Martin Cole, Ocala, FL (US); Kyle Vest, Waverly, NE (US); Nate Rasmussen, Lincoln, NE (US)

(21) Appl. No.: 18/110,824

(22) Filed: Feb. 16, 2023

Related U.S. Application Data
(63) Continuation-in-part of application No. 17/575,697, filed on Jan. 14, 2022.
(60) Provisional application No. 63/174,481, filed on Apr. 13, 2021.

(51) Int. Cl. F16K 31/04; F16L 19/08

(52) U.S. Cl. CPC F16K 31/041; F16L 19/086

(57) ABSTRACT

An apparatus for controlling fluid flow through a fluid flow meter comprises a meter coupling. The meter coupling includes a housing that has a valve, a drive assembly coupled to the valve, processing circuitry configured to instruct the drive assembly to transition the valve between an at least partially open position and an at least partially closed position, and an internal power supply configured to supply power to at least one of the processing circuitry and drive assembly.

### CROSS-REFERENCE TO RELATED APPLICATION(S)

This application is a continuation-in-part of U.S. patent application Ser. No. 17/575,697, entitled HINGE NUT FOR METER COUPLING VALVE, filed on Jan. 14, 2022, which claims priority to U.S. Provisional Patent Application No. 63/174,481 filed on Apr. 13, 2021, the entirety of which is incorporated herein by reference.

### FIELD OF THE INVENTION

The present invention relates to the field of valves in couplings for meters and more particularly to valves in couplings for water meters and gas meters.

### BACKGROUND OF THE INVENTION

Meters for fluids, such as water meters and gas meters, are utilized to determine the volume of fluid being supplied to a residential or commercial structure. The meter is assembled between the water lines or gas lines of the structure and the utility lines of the utility company supplying the water or gas. The meter then measures and records the volume of fluid flowing through the meter. The volume of the fluid is then read off of the meter either visually or remotely for processing.

Typically, a manual shut off valve is connected to the meter so that the provider or the party receiving the supply of water of gas can shut off the supply for any reason, such as stopping service or repairs. The manual shut off valve often requires a specialized tool or key to manually open or close the shut off valve. Further, the manual shut off valve often becomes covered in dirt due to its location in the ground and must be dug up to locate and operate. As the shut off valve must be manually operated, either the provider must send someone or the party receiving the service must be present to operate the shut off valve. Thus, problems may not be addressed in a timely fashion leading to water damage or unintended service interruptions. As well, there are additional problems in affixing new shut off valves (or other valves) to meters that are already installed in the ground.

### SUMMARY OF THE INVENTION

Embodiments of the present invention address deficiencies of the art in respect to valves in meter couplings and provide a novel and non-obvious apparatus for a hinge nut for a meter coupling. In an embodiment of the invention, the hinge nut includes at least two portions attached to each other by a hinge pin adjacent a distal end of each portion and the two portions are configured to be moved between an open position and a closed position. In the closed position, the hinge nut forms an outer surface and an opening forming an inner surface. The inner surface includes a first interior diameter adjacent a distal end of the opening and a second interior diameter adjacent the first interior diameter. The second interior diameter is greater than the first interior diameter and forms a lip and at least a portion of the second interior diameter includes threading.

In one aspect of the embodiment, the closed position of the hinge nut is secured by a fastener towards a distal end opposite the hinge pin. In another aspect of the embodiment, the fastener engages a nut where the nut is press fit into a hole located between the inner surface and outer surface of the hinge nut. In another aspect of the embodiment, the fastener engages a nut where the nut is molded into a hole located between the inner surface and outer surface of the hinge nut. In another aspect of the embodiment, the outer surface is polygonal in cross-section. In yet another aspect of the embodiment, the outer surface is hexagonal in cross-section. In even yet another aspect of the embodiment, the inner surface is cylindrical in cross-section.

In another embodiment of the invention, an apparatus includes a meter coupling attached to an end of a meter with a hinge nut. The end of the meter includes threading on its outer surface. The meter coupling includes an inlet at a distal end of the meter coupling, an outlet at a distal end opposite the inlet, where one of the distal ends forming a lip and other of the distal ends includes threading on an outer surface, and a housing between the inlet and the outlet where the housing includes a valve. The hinge nut is attached to the one of the distal ends forming the lip. The hinge nut includes at least two portions attached to each other by a hinge pin adjacent a distal end of each portion and the two portions are configured to be moved between an open position and a closed position. The closed position forms an outer surface and an opening forming an inner surface. The inner surface includes a first interior diameter adjacent a distal end of the opening and a second interior diameter adjacent the first interior diameter. The second interior diameter is greater than the first interior diameter and forms a lip and the lip of the hinge nut configured to retain the lip of the meter coupling. At least a portion of the second interior diameter includes threading and the threading of the hinge nut is configured to engage with the threading of the meter.

According to one or more embodiments of the invention, an apparatus for controlling fluid flow through a fluid flow meter comprises a meter coupling. The meter coupling includes a housing that has a valve, a drive assembly coupled to the valve, processing circuitry configured to instruct the drive assembly to transition the valve between an at least partially open position and an at least partially closed position, and an internal power supply configured to supply power to at least one of the processing circuitry and drive assembly.

In one aspect, the apparatus further comprises an actuator coupled to an outer surface of the housing. The actuator is connected to the valve such that rotation of the actuator transitions the valve between the at least partially open position and the at least partially closed position.

In another aspect, the processing circuitry is configured to receive a signal from a remote device.

In another aspect, the processing circuitry instructs the drive assembly to initiate the at least partial opening and closing of the valve based on the received signal.

In another aspect, the apparatus further comprises a fluid flow meter that has a first end and a second end opposite the first end. The meter coupling is attached to the fluid flow meter at the second end.

In another aspect, the meter coupling further comprises an inlet at a proximal end of the meter coupling and an outlet at a distal end of the meter coupling. The proximal end is proximate to the second end of the flow meter. The first end includes a threaded portion and the second end includes a lip portion.

In another aspect, a hinge nut is configured to couple the meter coupling to the fluid flow meter. The hinge nut has a first portion and a second portion attached to each other by a hinge pin adjacent to a distal end of each portion. The first and second portions are pivotably movable between an open hinge position and a closed hinge position around a portion of the second end of the fluid flow meter.

In another aspect, the hinge nut is coupled to the meter coupling at the lip portion.

In another aspect, when in the closed position, the hinge nut defines an aperture having a diameter sized to circumscribe at least a portion of at least one of the lip of the meter coupling and the second end of the flow meter.

According to one or more embodiments, a system for controlling fluid flow in a fluid flow meter comprises a meter coupling configured to be coupled to a fluid flow meter. The meter coupling comprises a housing that has: a valve; a drive assembly coupled to the valve; processing circuitry configured to instruct the drive assembly to transition the valve between an at least partially open position and an at least partially closed position; and an internal power supply configured to supply power to at least one of the processing circuitry and drive assembly.

In one aspect, an actuator is coupled to an outer surface of the housing. The actuator is connected to the valve such that rotation of the actuator transitions the valve between the at least partially open position and the at least partially closed position.

In another aspect, a remote device is configured to generate and transmit a signal to the processing circuitry. The processing circuitry instructs the drive assembly to at least partially open and close the valve based on the signal.

In another aspect, the system further comprises a fluid flow meter that has a first end and a second end opposite the first end. The meter coupling is attached to the fluid flow meter at the second end.

In another aspect, the meter coupling further comprises an inlet at a proximal end of the meter coupling and an outlet at a distal end of the meter coupling. The proximal end is proximate to the second end of the flow meter. The first end includes a threaded portion and the second end includes a lip portion.

In another aspect, a hinge nut is configured to couple the meter coupling to the fluid flow meter. The hinge nut includes a first portion and a second portion attached to each other by a hinge pin adjacent to a distal end of each portion. The first and second portions are pivotably movable between an at least partially open position and an at least partially closed position around a portion of the second end of the fluid flow meter.

In another aspect, the hinge nut is coupled to the meter coupling at the lip portion.

In another aspect, the processing circuitry is configured to measure a charge level of the internal power supply and compare the charge the measured charge level to a predetermined threshold.

In another aspect, the processing circuitry is configured to notify the remote device when the measured charge level falls below a predetermined threshold.

In another aspect, the predetermined threshold is a minimum threshold charge level to maintain proper operation of the controller.

In another aspect, a system for controlling fluid flow in a fluid flow meter comprises a fluid flow meter having a first end and a second end opposite the first end. A meter coupling is attached at the second end. The meter coupling comprises a housing that has a valve, a drive assembly coupled to the valve, an internal power supply configured to supply power to the motor gear drive assembly, and processing circuitry in communication with the drive assembly and the internal power supply. The processing circuitry is configured to receive a signal from a remote device, instruct the drive assembly to transition the valve between an at least partially open position and an at least partially closed position based on the received signal, measure a charge level of the internal power supply and compare the measured charge level to a predetermined threshold, and generate and transmit at least one of an audible, visual, and tactile alert to the remote device when the charge level deviates from the predetermined threshold.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an isometric assembled view of a pictorial illustration of a battery-powered valve in a meter coupling in accordance with the principles of the present invention;

FIG. 2 an isometric exploded view of a pictorial illustration of a battery-powered valve in a meter coupling in accordance with the principles of the present invention;

FIG. 3 is a left isometric exploded view of a pictorial illustration of a hinge nut of a battery-powered valve in a meter coupling in accordance with the principles of the present invention;

FIG. 4 a right isometric exploded view of a pictorial illustration of a hinge nut of a battery-powered valve in a meter coupling in accordance with the principles of the present invention;

FIG. 5 is an isometric assembled view of a pictorial illustration of a battery-powered valve in a meter coupling having an actuator is in a first position, in accordance with the principles of the present invention;

FIG. 6 is an isometric assembled view of a pictorial illustration of a battery-powered valve in a meter coupling having an actuator is in a second position, in accordance with the principles of the present invention;

FIG. 7 is a front isometric exploded view of a pictorial illustration of a meter coupling housing, in accordance with the principles of the present invention;

FIG. 8 is a cross-sectional view of the housing of FIG. 7;

FIG. 9 is a block diagram illustrating the components of the housing of FIGS. 7 and 8, and having an actuator coupled to the outside of the housing, in accordance with the principles of the present invention; and

FIG. 10 is a block diagram illustrating the components of the housing of FIGS. 7 and 8, without an actuator coupled to the housing, in accordance with the principles of the present invention.

### DETAILED DESCRIPTION OF THE INVENTION

Embodiments of the invention provide for an apparatus for a battery-powered valve in a meter coupling. In an embodiment of the invention, a battery-powered valve, such as a shut-off valve, in a meter coupling may be coupled to either end (the inlet or outlet) of an existing meter. The meter coupling also includes an inlet and outlet, where one side is connected to the meter and the other side is connected to the existing plumbing. The meter includes components for measuring the volume of fluid, such as water or gas, flowing through the meter.

The battery-powered valve may be contained within a housing of the meter coupling. The meter coupling may include a motor gear drive assembly, such as an actuator controller, that controls the valve, along with an internal transceiver or receiver to receive instructions to control the valve or the valve may be in communication with an external transceiver or receiver. Thus, an external transceiver or transmitter may transmit instructions to the motor gear drive assembly to open or close or partially open/close the valve. The valve may be powered by batteries, such as rechargeable or replaceable batteries that are contained within the meter coupling. In operation, the meter includes an inlet that attaches to the supply of fluid and an outlet that attaches to the fluid lines of the residential or commercial structure. The meter coupling that includes the battery-powered valve may be attached to the inlet or outlet of the meter. The transceiver of the valve receives instructions to open, close or partially open/close the valve to either allow, stop or restrict fluid flow. The valve then automatically opens, closes or partially opens/closes to provide sustenance flow to the occupant in response to the instructions. The valve may also be cycled intermittently to keep it from sticking so that it will continue to work.

The meter coupling may be coupled to the meter by a hinge nut so that the meter coupling can be easily retrofitted to existing meters. The hinge nut includes two halves or portions that are attached to each other at one end by a hinge pin. At an opposite end from the hinge pin, a fastener secures the ends of the hinge nut together. The fastener may be separate or built into the hinge nut. Thus, hinge nut can be easily moved from an open position to a closed position around an inlet or outlet of an existing meter to couple a meter coupling to the inlet or outlet of the existing meter and subsequently secured with the fastener. In order to couple the hinge nut to the inlet or outlet of the meter, threading of the hinge nut mates with corresponding threading on the outer portion of the inlet or outlet of the meter. Further, a retaining lip of the hinge nut engages a corresponding lip of the meter coupling on the inlet or outlet of the meter coupling. The meter coupling may also include a slip nut to tighten the end of the meter coupling lip against the hinge nut retaining lip to seal the meter coupling inlet or outlet, hinge nut, and meter inlet or outlet.

In operation, the inlet or outlet end of the meter coupling that includes the lip is placed facing the inlet or the outlet end of the meter. The hinge nut halves are moved from an open or “open hinge” position to a closed or “closed hinge” position around both the meter coupling end and the meter end. The hinge nut halves are then secured to each other with the fastener. The lip of the meter coupling is retained on the interior of the hinge nut by the retaining lip of the hinge nut halves and the threading of the meter engages with the corresponding threading of the hinge nut halves. A gasket or seal or washer may be placed between the threading of the meter and the meter coupling. The slip nut of the meter coupling is then tightened so that the end of the meter coupling lip is tightened against the hinge nut retaining lip. In this way, the meter coupling is able to be attached to an existing meter that would otherwise need to be removed in order to rotate the meter coupling along the threading of the meter.

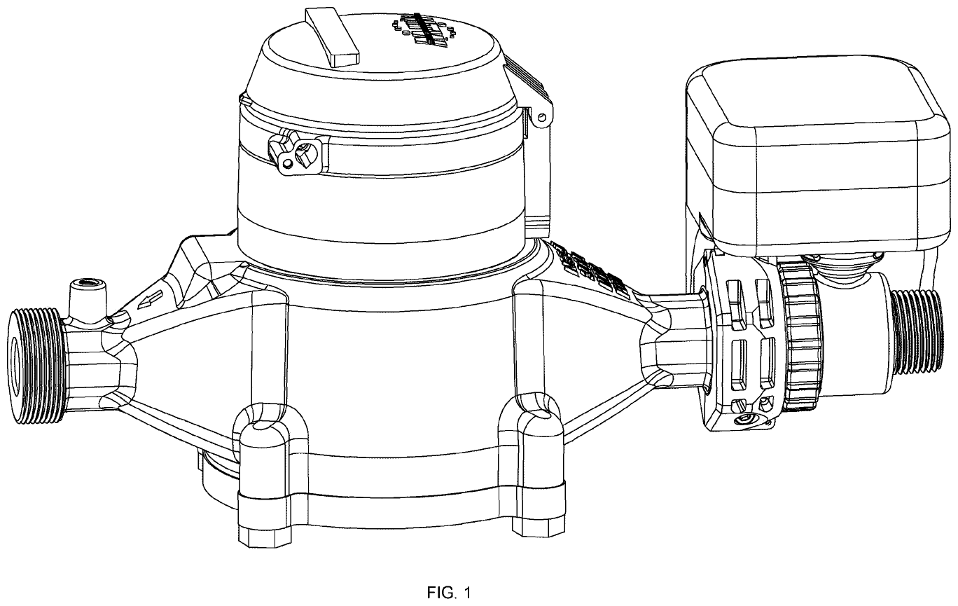

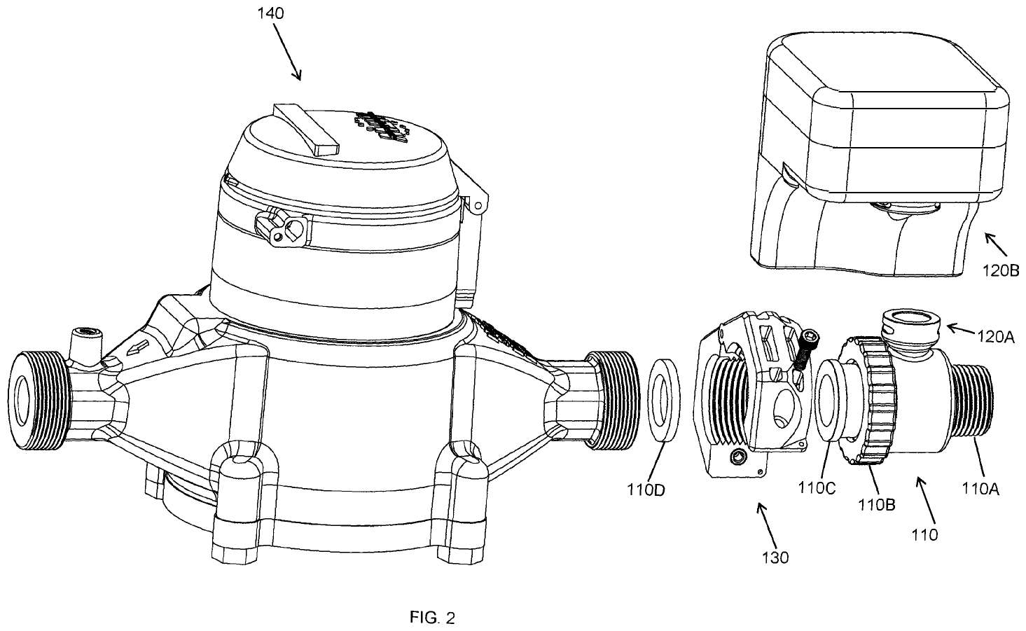

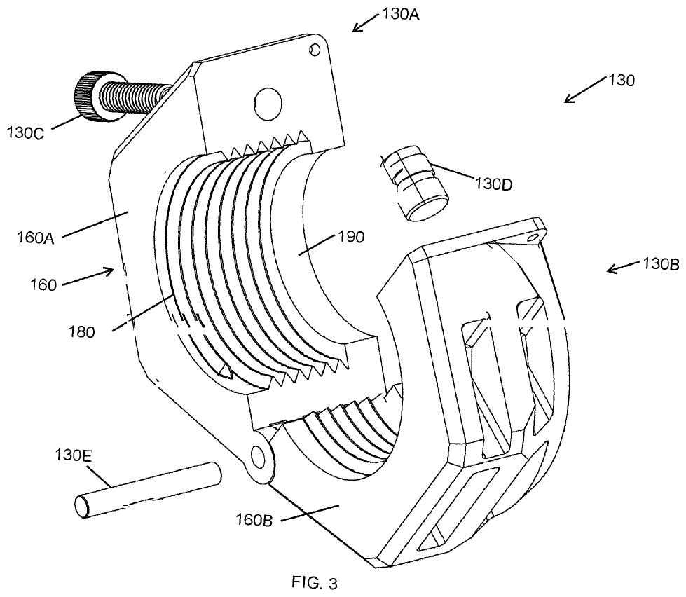

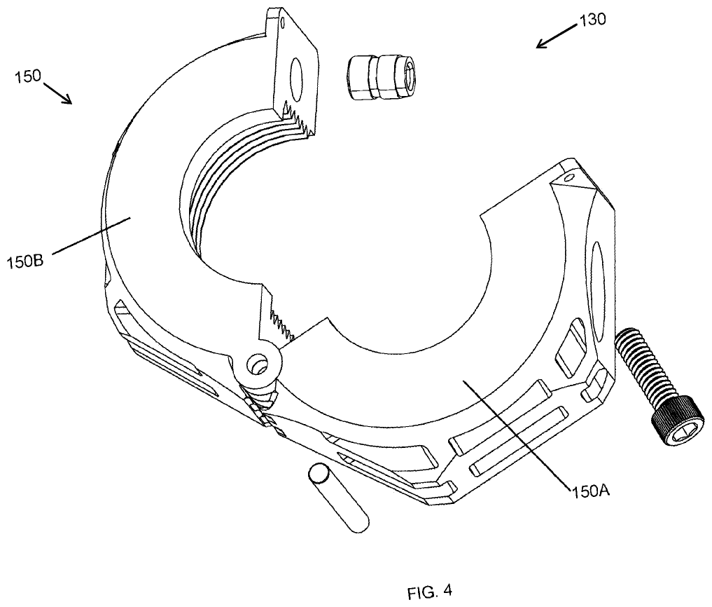

Referring now to the drawing figures in which like reference designators refer to like elements, there is shown in FIGS. 1 and 2 an exemplary system for monitoring fluid flow in a fluid flow meter and designated generally as “100.” As shown in FIGS. 1-2, the system 100 includes a tailpiece or meter coupling 110 coupled to a battery-powered valve disposed within a housing 120, which is formed of a first housing portion 120A and a second housing portion 120B that is on the meter tailpiece. The first and second housing portions 120A, 120B may house the valve with an internal battery and electronic device, such as a motor gear drive assembly and transceiver, to operate the valve. The first and second housing portions 120A, 120B may be any size, shape or configuration.

The meter coupling 110 may be coupled to either end of a fluid flow meter 140 with hinge nut 130. The threading 110A on the end of the meter coupling 110 allows the meter coupling to connect to either the supply lines from the utility company supplying the water or gas or the supply lines between the meter and the structure or dwelling. Similarly, the threading on the ends of the inlet or outlet of the meter 140 allows the meter 140 to connect to supply lines from the utility company supplying the water or gas or the supply lines between the meter and the structure or dwelling. Once hinge nut 130 is installed and rotated it will thereby tighten and secure the lip 110C of the meter coupling against a corresponding retaining lip 190 of the hinge nut. The hinge nut 130 is threaded on to the meter threads until tightening and securing the lip 110C of the meter coupling against a corresponding retaining lip 190 of the hinge nut which seals with seal 110D.

The meter coupling 110 may be secured to the meter with hinge nut, which is made up of the hinge nut components: hinge nut half 130A, hinge nut half 130B, hinge nut fastener 130C, hinge nut fastener nut 130D, and hinge pin 130E. The hinge nut halves 130A, 130B may be permanently attached by the hinge pin 130E or the hinge pin may be removable. The hinge nut includes a face 150 facing the meter coupling and an opposite face 160 facing the meter. As can be seen, the hinge nut 130 is made up of two halves 130A and 130B that are attached to each other to form the hinge nut. Thus, face 150 is made up faces 150A, 150B of the respective half and face 160 is made up faces 160A, 160B of the respective half.

On the exterior of the hinge nut 130, hinge nut fastener 130C and hinge nut fastener nut 130D secures the hinge nut halves 130A, 130B to each other. The hinge nut halves 130A, 130B may include grooves or channels or holes on the exterior sized and shaped for the corresponding hinge nut fastener 130C and hinge nut fastener nut 130D. The hinge nut fastener nut 130D and/or the hinge nut fastener 130C may be molded into the hole on the respective hinge nut half. In this way, the respective hinge nut half would include a molded-in threaded insert and the opposite hinge nut half would include corresponding female threading, so the two can be bolted together. Alternatively, the hinge nut fastener nut 130D may be press fit into the hole on the exterior of the hinge nut (in between the inner and outer surface of the closed hinge nut) when it is secured to the hinge nut fastener 130C to secure the hinge nut halves 130A, 130B together. An outer surface of the hinge nut is formed when the hinge nut halves are moved to a closed hinge position. The figures depict the surface as substantially hexagonal in cross-section, however, any polygonal or cylindrical cross-section is within the scope of this invention.

The opening in the hinge nut 130 forms an interior or inner surface of the hinge nut that is cylindrical in cross-section when in the closed position. The inner surface of the hinge nut includes a include a retaining lip 190 formed by the respective halves on one end of the opening. While the retaining lip is shown as cylindrical in cross-section, the retaining lip being polygonal in cross-section is within the scope of this invention. Further, the hinge nut halves include threading 180 formed by the respective halves adjacent the retaining lip towards the opposite end of the opening. The retaining lip is located towards the end adjacent face 150 facing the meter coupling and the threading is located towards the end adjacent face 160 facing the meter. As can be seen, the interior diameter of the portion of the inner surface of the hinge nut with the threading is greater than the interior diameter of the portion of the inner surface of the hinge nut with the retaining lip, which thereby forms the retaining lip. The retaining lip is configured to engage or retain lip 110C of the meter coupling with a gasket or seal or washer 110D in between and the threading is configured to engage the corresponding threading on the inlet or outlet of the meter 140.

As depicted in FIGS. 1 and 2, the meter coupling 110 may include housing 120A, 120B. Housing 120A, 120B may include a valve, a motor gear drive assembly (not shown) configured to open and close the valve, a transceiver (not shown) in communication with the motor gear drive assembly and configured to receive instructions to open and close the valve, and a power supply or batteries (not shown) in communication with the motor gear drive assembly and transceiver and configured to power the motor gear drive assembly and receiver. Thus, when an external or remote transmitter or transceiver transmits instructions to the receiver or transceiver of the meter coupling 110, the valve may automatically open or close. If the meter coupling 110 also includes a transmitter, so that the receiver and transmitter are a transceiver, the transmitter may send a status of the valve or a status of the batteries to the corresponding external transceiver. The valve in housing 120A can also be manually operated with a manual handle (not shown) when housing 120B is removed.

The battery-powered valve, the meter coupling 110, the hinge nut 130 components, and the meter 140, may be manufactured from materials including, but not limited to, bronze, cast iron, stainless steel, plastics or other non-corrosive materials, or any combination of the materials. The meter 140 may be cast into place or assembled separately. The meter coupling 110, including the housing 120 for the battery-powered valve and electronic components, may be molded into place or assembled separately and coupled to the meter 140 with the hinge nut 130.

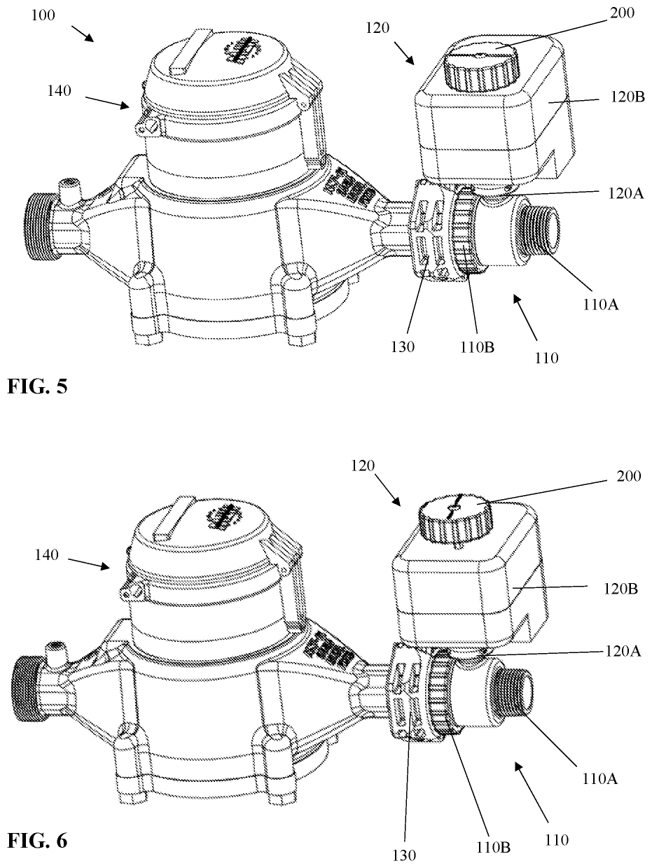

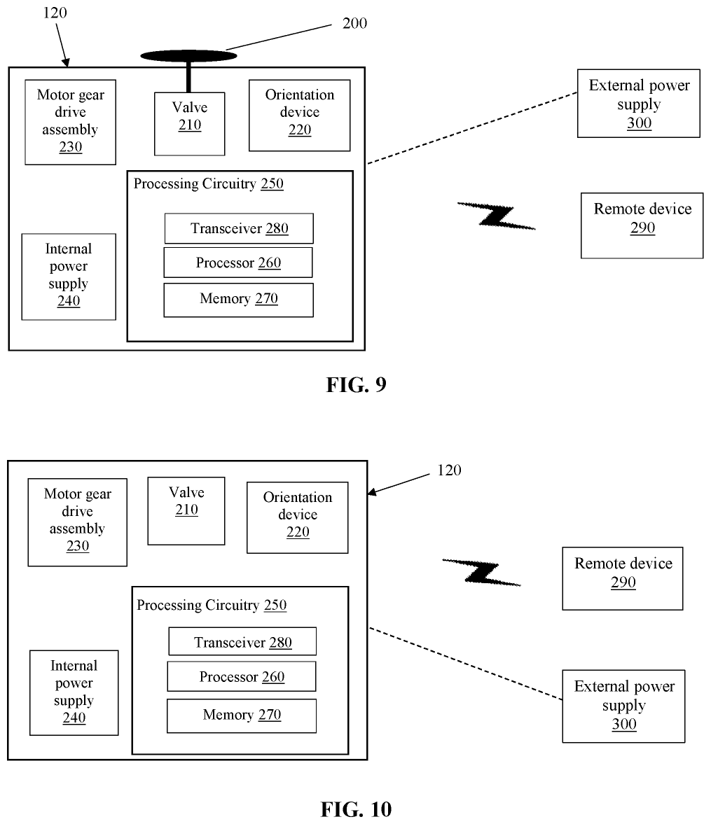

Now referring to FIGS. 5-10 one or more exemplary embodiments of the housing 120 is shown. As shown in FIGS. 5 and 6, the housing 120 may include an actuator 200. The actuator 200 may be a lever, handle, disc, rotary, spring, etc., configured to control manual operation of the valve 210 (shown in FIGS. 9 and 10). In some embodiments, the actuator 200 may be a disc configured to be rotated in a clockwise and counterclockwise direction in order to open and close (or partially open and/or close) the valve 210. Additionally, in one or more embodiments, the housing 120 and/or actuator 200 may each be sufficiently resistant to water or water intrusion from the external environment such that normal operation of the housing 120 components described herein may be maintained in the affected the housing 120 is exposed to water, rain, snow, or other fluid sources. In other words, the housing 120 and/or actuator 200 are each waterproof.

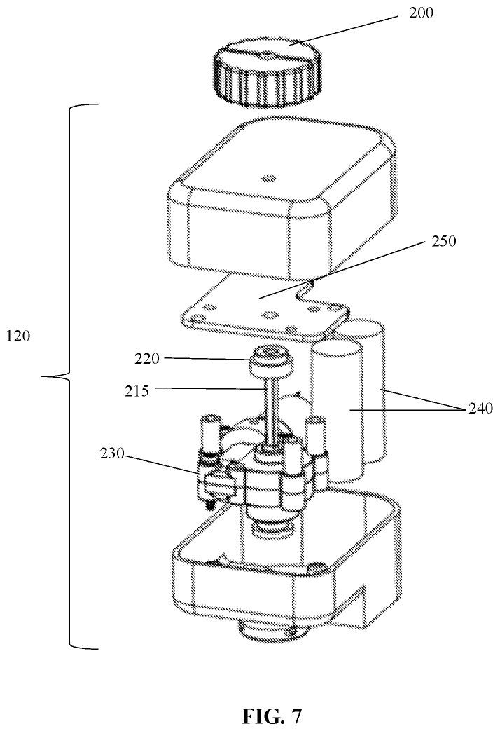

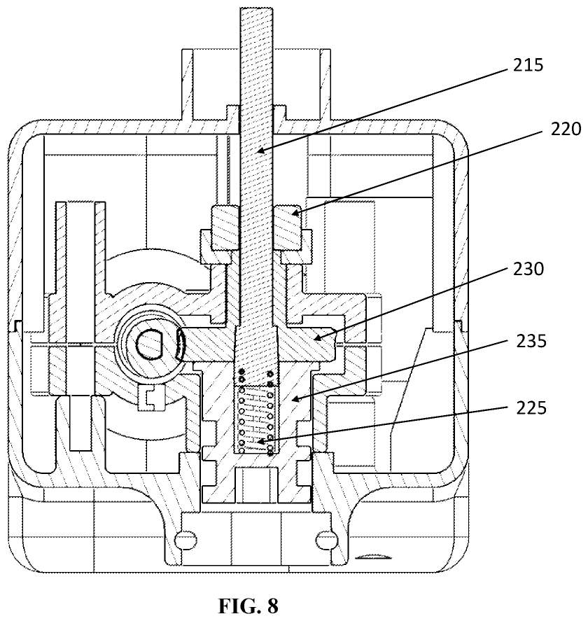

As shown in FIGS. 7-8, the actuator may include or be coupled to a rotatable shaft 215 that extends within the housing 120 and the housing 120 further includes an orientation device 220, a biasing element or spring 225 configured to be in contact with an end of the shaft 215 within the housing 120, and a motor gear drive assembly 230. When advanced into a coupling member 235, the shaft 215 may exert force upon or compress the spring 225 and disconnect from the motor gear drive assembly 230, which then allows the valve 210 to turn or rotate independently of the motor gear drive assembly 230. In some embodiments, when the shaft 215 is released back up from the coupling member 235, it will only allow the shaft 215 and a drive gear of the drive assembly 230 to fit back together in one orientation so that a rotation sensor (not shown) knows when the valve is fully and/or partially open and closed following a manual override. This allows the actuator 200 to transition from automatic operation to manual operation without any hardware changes or substitutions. As a non-limiting example, the orientation device 220 may be a magnet that is configured to determine whether the valve 210 is fully and/or partially open or closed. The magnet interacts with a corresponding magnetic sensor (not shown) that is located within the processing circuitry (discussed in more detail below) and provides feedback to the processing circuitry about the rotation of the shaft 215, therefore controlling whether the valve 210 is open, closed, or at least partially open or closed.

When rotated or engaged by a user, the actuator 200 may transition between a first position and a second position to manually control the opening and closing (or at least partial opening and closing) of the valve 210 in the event of an electrical, mechanical, and/or communication failure or fault of the internal power supply 240. For example, as shown in FIG. 5, the actuator 200 is flush or in contact with the outer surface of the housing 120. However, as shown in FIG. 6, the actuator is not directly flush with the outer surface of the housing 120 and instead is separated by a small gap. As a non-limiting example, rotating the actuator 200 to be contact with the outer surface of the housing 120 may cause the shaft 215 to be advanced into the coupling member 235 and disconnect from the drive assembly 230, allowing the valve 210 to close. As such, rotating the actuator 200 to be separated from the outer surface of the housing 120 may thus open the valve 210 by disconnecting the shaft 215 from the coupling member 235. However, in other embodiments, rotating the actuator to be in contact with the outer surface of the housing 120 may open the valve 210 and rotating the valve to be separated from the outer surface of the housing may close the valve 210.

As shown in FIGS. 7, 9, and 10, in one or more embodiments, the housing 120 includes an internal power supply 240 and processing circuitry 250 configured to execute instructions or algorithms to provide for the automated operation and performance of the features, sequences, calculations, or procedures described herein. In one or more embodiments, the processing circuitry 250 may include a processor 260, a memory 270, a transceiver 280, and a corresponding magnetic sensor that interacts with the orientation device 220. The internal power supply 240 and the processing circuitry 250 are each potted for resistance to the potential intrusion of water, moisture, or other corrosive agents. The memory 270 may be in electrical communication with the processor 260 and have instructions that, when executed by the processor 260, configure the processor 260 to receive, process, or otherwise use signals from an external or remote device 290 that are transmitted to and received by the transceiver 280. As a non-limiting example, the remote device 290 may be, for example, a computer, laptop, tablet, mobile device, and/or smart device, or other cloud-based or storage device, configured to generate and transmit a system signal to transceiver 280. The remote device 290 may be in wired and/or wireless communication with the processing circuitry 250, including the transceiver 280, via a Wi-Fi, Bluetooth®, cellular, mesh, radio, or Near Field Communication (NFC) network, General Packet Radio Service (GPRS) network, the Global System for Mobile Communications (GSM) network, 3G, 4G, 5G and EDGE enabled networks, Wireless Access Point (WAP) networks, or any other form of short or long-distance communication. The transceiver 280 may be compatible with the Internet of Things (IoT) technologies, and use communications from Short Message Service (SMS) and electronic mail messages. As such, the transceiver 280 may be a communication circuit that is configured and/or programmed to transmit and/or receive the system signal, messages, or other instructions to and/or from one or more remote devices 290 over the wired and/or wireless connection. The received signals, messages, and/or instructions are then analyzed by the processing circuitry 250, which then sends a command or signal to, or otherwise instructs, the motor gear drive assembly 230 to transition the valve 210 between an open position and closed position. As such, it is to be understood that the motor gear drive assembly 230 is configured to be in communication with, and receive signals, commands, or messages from, the processing circuitry 250. Additionally, it is to be understood that although the transceiver 280 is shown as being part of the processing circuitry 250, in some embodiments, the transceiver 280 may also be a component separate from the processing circuitry 250 but included within the housing 120.

It is to be understood that, as described herein, the system signal may also be a command, message, or instruction to open or close the valve 210. In some embodiments, the system signal may also include the fluid parameter signal indicative of the amount of the fluid passing through the valve 210 and/or the flow rate of the fluid, the parameter data, the identification data, and/or the time data. As a non-limiting example, the parameter data may include or refer to the settings of the flow meter 140 and the valve 210, such as the meter parameters in cubic feet or gallons and how far the valve 210 opens and closes or whether the valve 210 stops in between the fully open and closed positions (i.e., partially open or closed). The identification data may include the duration or period of time that the valve 210 is opened or closed, or in an open-close cycle. Further, the system signal received from the remote device 290 may also contain a command update message or a data update message in order to update the system components of the housing 120 described herein. The command update message may be an instruction for the processing circuitry 250 to follow, such as disabling or deactivating the system. A data update message may include a firmware update for the processing circuitry 250, sensors, and/or logic.

As mentioned above, the housing 120 includes the internal power supply 240 disposed therein. The internal power supply 240 is in communication with and is configured to supply power to any of the processing circuitry 250, orientation device 220, and/or the motor gear drive assembly 230 for controlling the opening and closing of the valve 210. According to one or more embodiments, the internal power supply 240 may include one or more batteries that are configured to supply power to the various components of the housing 120 until the batteries run out of charge. Once the batteries run of out charge, a user or operator may remove the depleted batteries and replace them with charged batteries.

Additionally, and or alternatively, in one or more embodiments, the processing circuitry 250, orientation device 220, and/or the motor gear drive assembly 230 may also be in communication with an external power supply 300, which can be used as a primary and/or secondary power source in addition to, or in place of, the internal power supply 240. The external power supply 300 may be a power source disposed within a commercial or residential building, power generator, battery pack, motor or electric vehicle, or any other device configured to provide power output to the components disposed within the housing 120.

Prior to, during, or after operation of the fluid flow meter 140, the processing circuitry 250 is further configured to measure a charge level of the internal power supply 240 in order to maintain proper operation of the processing circuitry 250, motor gear drive assembly 230, and/or orientation device 220. Once the charge level is measured, the processing circuitry 250 may compare the measured charge level to a predetermined threshold stored within the memory 270 or retrievable from remote device 290. The predetermined threshold may be a predetermined minimum charge level necessary to maintain proper or normal operation of the processing circuitry 250, motor gear drive assembly 230, and/or orientation device 220. If the measured charge level falls below the predetermined threshold, the processing circuitry 250 may automatically generate and transmit at least one of an audible, verbal, or tactile alert to the remote device 290 so that a user or operator is notified that the internal power supply 240 is failing or needs to be replaced. In one or more embodiments, when it is determined that the internal power supply 240 is failing, the housing 120, and the components disposed therein, may instead be powered by the external power supply 300 as a backup power supply. In the event of a mechanical or electrical failure from the internal power supply 240 and/or external power supply 300, the actuator 200 may be manually engaged by the user or operator to open and close the valve 210. However, it is to be understood that the actuator 200 may also be manually engaged by the user to open and close—or partially open and close—the valve 210 at any other time desired by the user or operator.

Further, as shown in FIG. 10, in one or more embodiments, an actuator 200 may not be coupled to the outer surface of the housing 120. Thus, opening and closing of the valve must be automatically initiated by the processing circuitry 250 and motor gear drive assembly 230 and powered by at least one of the internal power supply 240 and external power supply 300.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. An apparatus for controlling fluid flow through a fluid flow meter, comprising:
a meter coupling, the meter coupling including a housing having:
a valve;
a drive assembly coupled to the valve;
processing circuitry configured to instruct the drive assembly to transition the valve between an at least partially open position and an at least partially closed position; and
an internal power supply configured to supply power to at least one of the processing circuitry and drive assembly.

2. The apparatus of claim 1, further comprising an actuator coupled to an outer surface of the housing, the actuator being connected to the valve such that rotation of the actuator transitions the valve between the at least partially open position and the at least partially closed position.

3. The apparatus of claim 1, wherein the processing circuitry is configured to receive a signal from a remote device.

4. The apparatus of claim 3, wherein the processing circuitry instructs the drive assembly to initiate the at least partial opening and closing of the valve based on the received signal.

5. The apparatus of claim 1, further comprising a fluid flow meter having a first end and a second end opposite the first end, the meter coupling is attached to the fluid flow meter at the second end.

6. The apparatus of claim 5, wherein the meter coupling further comprises:
an inlet at a proximal end of the meter coupling, the proximal end being proximate to the second end of the flow meter;
an outlet at a distal end of the meter coupling; and
wherein the first end includes a threaded portion and the second end includes a lip portion.

7. The apparatus of claim 6, further comprising:
a hinge nut configured to couple the meter coupling to the fluid flow meter, the hinge nut having:
a first portion and a second portion attached to each other by a hinge pin adjacent to a distal end of each portion, the first and second portions being pivotably movable between an open hinge position and a closed hinge position around a portion of the second end of the fluid flow meter.

8. The apparatus of claim 7, wherein the hinge nut is coupled to the meter coupling at the lip portion.

9. The apparatus of claim 7, wherein, when in the closed position, the hinge nut defines an aperture having a diameter sized to circumscribe at least a portion of at least one of the lip of the meter coupling and the second end of the flow meter.

10. A system for controlling fluid flow in a fluid flow meter, comprising:
a meter coupling configured to be coupled to a fluid flow meter, the meter coupling comprising a housing having:
a valve;
a drive assembly coupled to the valve;
processing circuitry configured to instruct the drive assembly to transition the valve between an at least partially open position and an at least partially closed position; and
an internal power supply configured to supply power to at least one of the processing circuitry and drive assembly.

11. The system of claim 10, further comprising:
an actuator coupled to an outer surface of the housing, the actuator is connected to the valve such that rotation of the actuator transitions the valve between the at least partially open position and the at least partially closed position.

12. The system of claim 10, further comprising a remote device configured to generate and transmit a signal to the processing circuitry, the processing circuitry is configured to instruct the drive assembly to at least partially open and close the valve based on the signal.

13. The system of claim 10, further comprising a fluid flow meter having a first end and a second end opposite the first end, the meter coupling is attached to the fluid flow meter at the second end.

14. The system of claim 13, wherein the meter coupling further comprises:
an inlet at a proximal end of the meter coupling, the proximal end being proximate to the second end of the flow meter;
an outlet at a distal end of the meter coupling; and
wherein the first end includes a threaded portion and the second end includes a lip portion.

15. The system of claim 14, further comprising a hinge nut configured to couple the meter coupling to the fluid flow meter, the hinge nut having:
a first portion and a second portion attached to each other by a hinge pin adjacent to a distal end of each portion, the first and second portions being pivotably movable between an open hinge position and a closed hinge position around a portion of the second end of the fluid flow meter.

16. The system of claim 15, wherein the hinge nut is coupled to the meter coupling at the lip portion.

17. The system of claim 10, wherein the processing circuitry is configured to measure a charge level of the internal power supply and compare the measured charge level to a predetermined threshold.

18. The system of claim 17, wherein the processing circuitry is configured to notify the remote device when the measured charge level falls below a predetermined threshold.

19. The system of claim 18, wherein the predetermined threshold is a minimum threshold charge level to maintain proper operation of the controller.

20. A system for controlling fluid flow in a fluid flow meter, comprising:
a fluid flow meter having a first end and a second end opposite the first end;
a meter coupling attached at the second end, the meter coupling comprising a housing having:
a valve;
a drive assembly coupled to the valve;
an internal power supply configured to supply power to the drive assembly; and
processing circuitry in communication with the drive assembly and the internal power supply, the processing circuitry being configured to:
receive a signal from a remote device; and
instruct the drive assembly to transition the valve between an at least partially open position and an at least partially closed position based on the received signal.
